(19) United States
(12) Patent Application Publication
(10) Pub. No.: US 2026/0291095 A1
(43) Pub. Date: Sep. 24, 2026

(54) CONNECTOR

(71) Applicant: Panasonic Intellectual Property Management Co., Ltd., Osaka (JP)

(72) Inventors: TAKASHI KOZAKI, Mie (JP); RYOSUKE SHIMOMURA, Mie (JP)

(21) Appl. No.: 19/475,446

(22) PCT Filed: May 22, 2024
(86) PCT No.: PCT/JP2024/018907

§ 371 Date: Oct. 15, 2025

(30) Foreign Application Priority Data
Jul. 11, 2023 (JP) 2023-114012

(51) Int. Cl. H01R 12/71; H01R 13/11

(52) U.S. Cl. CPC H01R 12/716; H01R 13/11

(57) ABSTRACT

A connector includes a housing and a terminal. The housing includes a bottom wall and a wall portion protruding upward from the bottom wall. The bottom wall has a through-hole passing through the hosing along a first axis. The terminal is held by the housing. The terminal includes a connection piece, a first contact piece, a side piece, a contact arm, and a first curved portion. An upper surface and a lower surface of the first curved portion are covered by the housing. The first curved portion is embedded in the housing such that a first end of a bottom piece of the contact arm is exposed from the housing.

### TECHNICAL FIELD

The present disclosure relates to a connector, and more particularly to a connector configured to be fitted to a mating connector.

### BACKGROUND ART

PTL 1 discloses a receptacle connector configured to be fitted to a plug connector. A terminal of the receptacle connector includes a base portion, a contact arm portion, and a connection portion. The base portion is held by integral molding on a bottom wall of a housing. The contact arm portion extends in a connector insertion and extraction direction in a groove in a standing wall standing from the bottom wall of the housing from one end of the base portion and is elastically deformable in a connector width direction. The connection portion is provided at a portion extending from the other end of the base portion and is solderable to a mounting surface.

### CITATION LIST

### Patent Literature

PTL 1: Japanese Patent Laid-Open Publication No. 2012-160360

### SUMMARY OF INVENTION

In the connector described above, it is desired that the contact reliability between the terminals may be ensured while increasing the holding force for holding the terminals of the housing.

A connector device according to one aspect of the present disclosure is configured to be fitted to a mating connector from below along a first axis. The connector includes a housing and a terminal. The housing includes a bottom wall and a wall portion protruding upward from the bottom wall, the bottom wall having a through-hole passing through the bottom wall along the first axis. The terminal is held by the housing. The terminal includes a connection piece, a first contact piece, a side piece, a contact arm, and a first curved portion. The first contact piece is configured to contact a mating terminal of the mating connector. The side piece connects the connection piece to an upper end of the first contact piece, the side piece including a part embedded in the housing. The contact arm is movable with respect to the housing. The first curved portion is curved, and connects a lower end of the first contact piece to the contact arm. The contact arm includes a second contact piece, a bottom piece, and a second curved portion. The second contact piece faces the first contact piece along a facing axis intersecting with the first axis. The second contact piece is configured to contact the mating terminal of the mating connector. The bottom piece is disposed in the through-hole and extends linearly along the facing axis. The bottom piece has a first end and a second end opposite to the first end, the first end being connected to the first curved portion. The second curved portion is curved, and connects a lower end of the second contact piece to the second end of the bottom piece. The housing covers an upper surface and a lower surface of the first curved portion, and the first curved portion is embedded in the housing such that the first end of the bottom piece of the contact arm is exposed from the housing.

The present disclosure provides an advantage that the contact reliability between the terminals is ensured while increasing the holding force for holding the terminals of the housing.

### BRIEF DESCRIPTION OF DRAWINGS

FIG. 1 is an exploded perspective view of a connector device according to an exemplary embodiment.

FIG. 2 is a top view of the connector device in a fitted state.

FIG. 3A is a perspective view of a first terminal and a first shield of a first connector of the connector device.

FIG. 3B is a perspective view of a second terminal and a second shield of a second connector of the connector device.

FIG. 4 is a perspective view of the first connector of the connector device.

FIG. 5 is a perspective view of a first housing of the first connector.

FIG. 6 is a perspective view of the first terminal and a first inner shield of the first connector.

FIG. 7 is a perspective view of the second connector of the connector device.

FIG. 8 is a perspective view of a second housing of the second connector.

FIG. 9 is a perspective view of the second terminal and a second inner shield of the second connector.

FIG. 10 is a cross-sectional view of the connector device along line X-X shown in FIG. 2.

FIG. 11A is a perspective view of a first connection terminal of the first connector.

FIG. 11B is a perspective view of a modification of the first connection terminal of the first connector.

FIG. 12 is a partially cutaway perspective view of the first housing and the first connection terminal of the first connector.

FIG. 13 is a partial cross-sectional view of the first housing and the first connection terminal.

FIG. 14 is a partial bottom view of the first housing and the first connection terminal.

### DESCRIPTION OF EMBODIMENTS

A connector according to an embodiment will be described below with reference to the drawings. However, the following embodiment is merely one of various embodiments of the present disclosure. The following embodiment can be modified in various ways according to the design or the like, as long as the object of the present disclosure can be achieved. The drawings described in the following embodiment are schematic drawings, and a ratio of a size to a thickness of each component in each drawing does not necessarily reflect the actual dimension ratio.

### (1) Overview

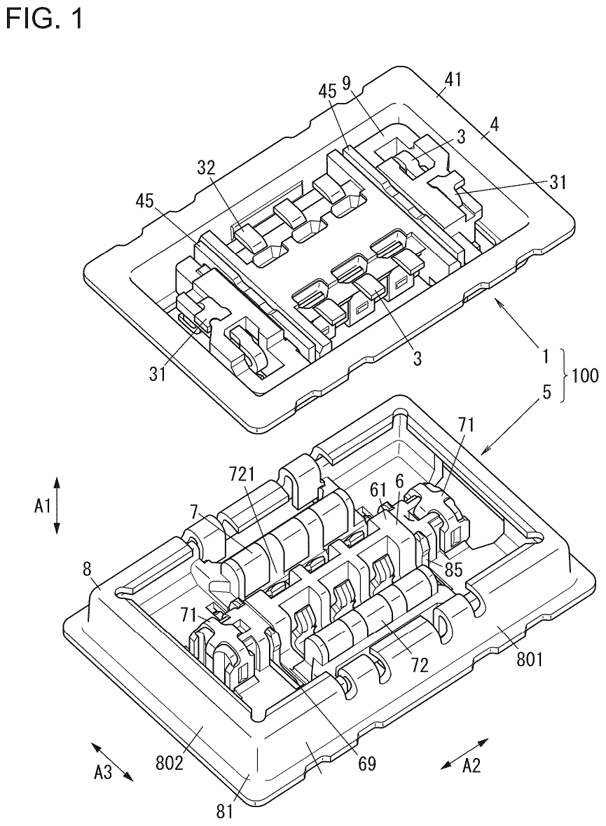

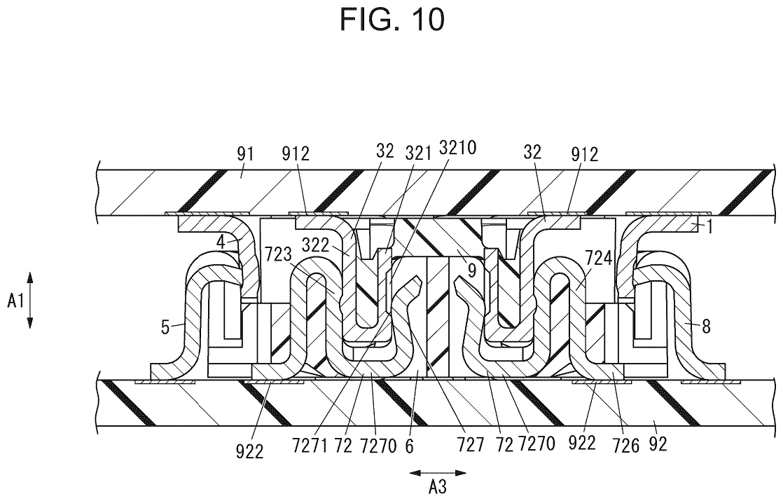

As illustrated in FIG. 1, connector 5 (hereinafter also referred to as a “first connector”) according to an exemplary embodiment constitutes connector device 100 together with mating connector 1 (hereinafter also referred to as a “second connector”). For example, connector device 100 is used to electrically connect circuit boards mounted on a mobile terminal, such as a smartphone. For example, first connector 5 is attached to first circuit board 92 (see FIG. 10), such as a printed wiring board or a flexible printed wiring board, of an antenna module (antenna in package (AiP)). For example, second connector 1 is attached to second circuit board 91 (see FIG. 10), such as a printed wiring board or a flexible printed wiring board. The use of connector device 100 is not intended to be limited, and connector device 100 may be used in an electronic device, such as a camera module, other than the mobile terminal. The use of connector device 100 is not limited to the use of electrically connecting circuit boards, and may be, for example, a use of electrically connecting components, such as between a circuit board and a display and between a circuit board and a battery. In the figures other than FIG. 10, illustration of first circuit board 92 and second circuit board 91 is omitted for convenience.

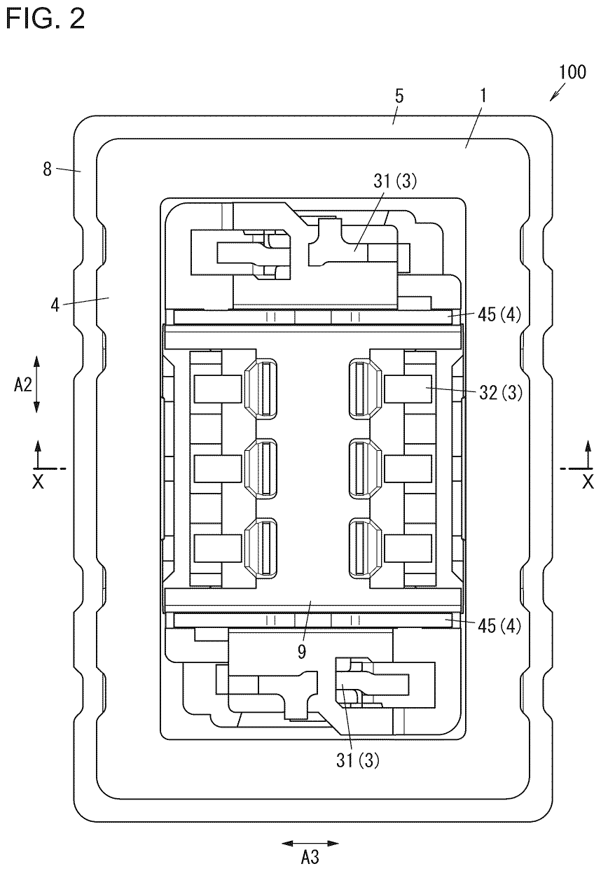

As illustrated in FIG. 1, second connector 1 is configured to be fitted to first connector 5 by moving relative to first connector 5 in one direction along first axis A1 toward first connector 5. A direction in which first connector 5 and second connector 1 are fitted to each other (a direction along first axis A1) may be referred to as an up-down direction. When first connector 5 is fitted to second connector 1 along the up-down direction, a side on which first connector 5 is located may be referred to as “lower”, and a side on which second connector 1 is located may be referred to as “upper”. That is, first connector 5 is configured to be fitted to second connector 1 from below along first axis A1. However, these definitions of direction are not intended to limit the usage form of connector device 100. A state in which first connector 5 and second connector 1 are fitted to each other (see FIG. 2) is referred to as a “fitted state”.

Two axes perpendicular to first axis Al are referred to as second axis A2 and third axis A3. As illustrated in FIG. 1, second axis A2 extends along a longitudinal direction of connector device 100. Third axis A3 extends along a lateral direction of connector device 100. Second axis A2 and third axis A3 may be referred to as a front-rear direction and a left-right direction, respectively.

As illustrated in FIG. 1, connector 5 (a first connector) 5 includes housing 6 (hereinafter also referred to as “a first housing”) and terminal 72 (hereinafter also referred to as “a first connection terminal”).

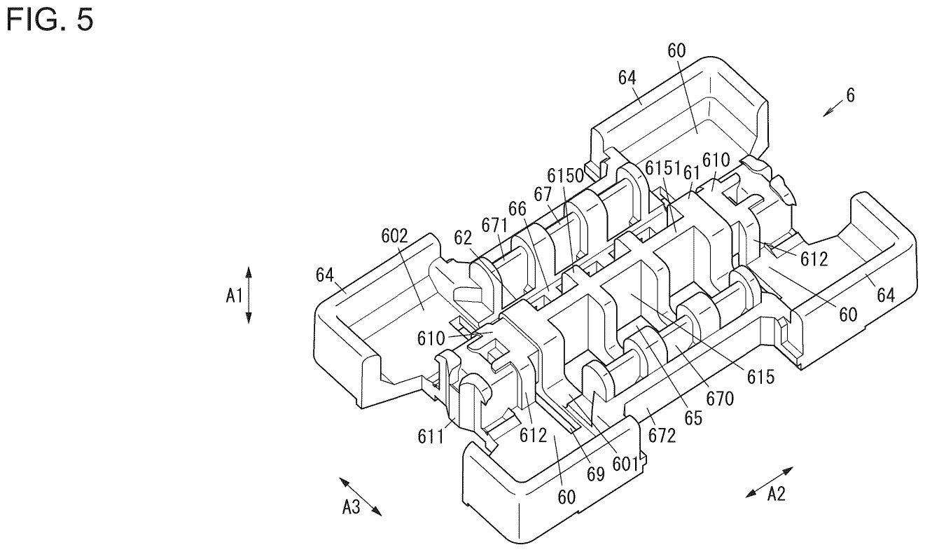

As illustrated in FIG. 5, housing 6 (the first housing) includes bottom wall 66 (hereinafter, also referred to as a “first inner bottom wall”) and a wall portion protruding upward from bottom wall 66. Bottom wall 66 has through-hole 65 passing through the bottom wall along first axis A1 In accordance with the present embodiment, the wall portion includes first wall portion 67 (a second inner wall) and second wall portion 61 (a central wall portion).

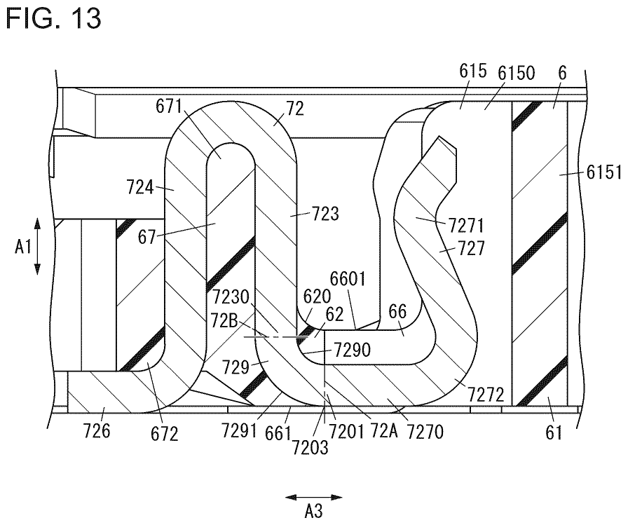

As illustrated in FIG. 13, terminal 72 (a first connection terminal) is held by housing 6 (the first housing). Terminal 72 (the first connection terminal) includes connection piece 726, first contact piece 723, side piece 724, contact arm 727, and first curved portion 729. First contact piece 723 is configured to contact mating terminal 32 (hereinafter, also referred to as “a second connection terminal”) of mating connector 1 (the second connector) in the fitted state.

As illustrated in FIG. 13, side piece 724 connects connection piece 726 to an upper end of first contact piece 723. A part of side piece 724 is embedded in housing 6 (the first housing). First curved portion 729 is curved. First curved portion 729 connects lower end 7230 of first contact piece 723 to contact arm 727.

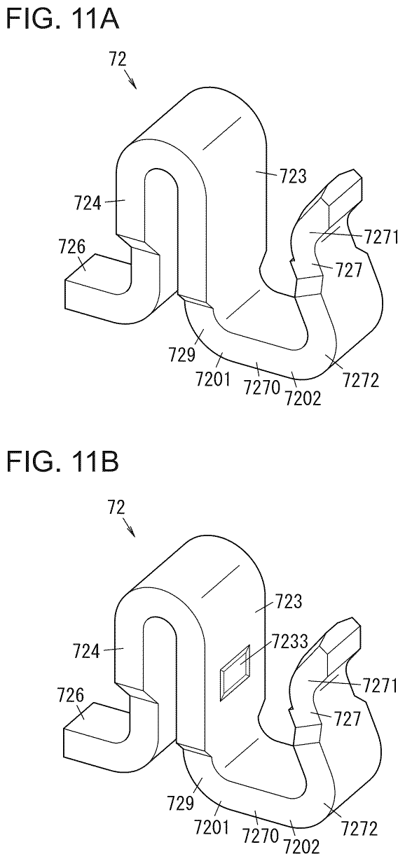

As illustrated in FIG. 11A and FIG. 13, contact arm 727 includes second contact piece 7271, bottom piece 7270, and second curved portion 7272. Second contact piece 7271 faces first contact piece 723 on a facing axis intersecting with first axis A1, that is, non-parallel to first axis A1. First contact piece 723 is configured to contact mating terminal 32 (the second connection terminal) of the mating connector. The facing axis extends along, for example, third axis A3.

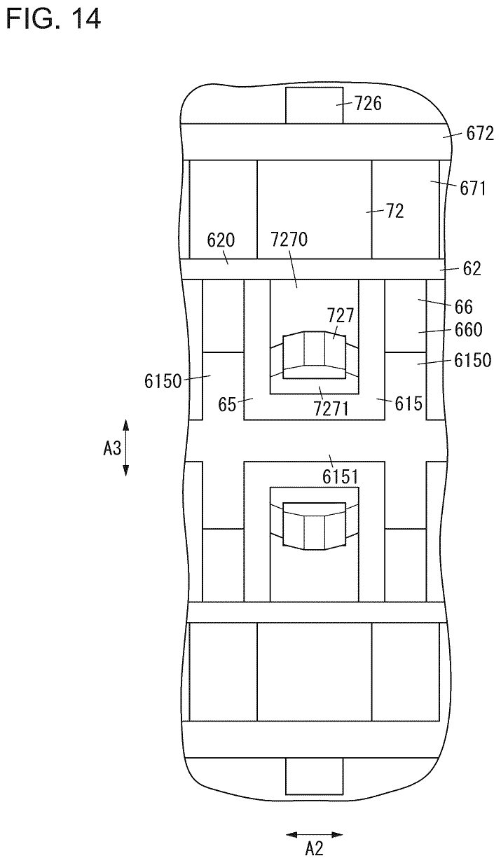

As illustrated in FIG. 11A, bottom piece 7270 includes first end 7201 and second end 7202 opposite to first end 7201. Bottom piece 7270 linearly extends along the facing axis (the axis along which first contact piece 723 and second contact piece 7271 face each other). First end 7201 of bottom piece 7270 is connected to first curved portion 729. As illustrated in FIG. 13 and FIG. 14, bottom piece 7270 is disposed in through-hole 65.

Second curved portion 7272 is curved. As illustrated in FIG. 11A, second curved portion 7272 connects a lower end of second contact piece 7271 to second end 7202 of bottom piece 7270.

In connector 5 (the first connector), as illustrated in FIG. 13, upper surface 7290 and lower surface 7291 of first curved portion 729 are covered by housing 6 (the first housing), and first curved portion 729 is embedded in housing 6 (the first housing) such that first end 7201 of bottom piece 7270 of contact arm 727 is exposed from housing 6 (the first housing). This configuration increases a holding force for holding terminal 72 (the first connection terminal) of housing 6 (the first housing) 6.

In connector 5 (the first connector) according to the embodiment, bottom piece 7270, second curved portion 7272, and second contact piece 7271 of contact arm 727 are connected to one another in this order. Bottom piece 7270, second curved portion 7272, and second contact piece 7271 are exposed from housing 6 (the first housing). Therefore, contact arm 727 is deformable with respect to housing 6 (the first housing) from one end of bottom piece 7270 of contact arm 727. Therefore, a portion of the contact arm that can be bent when second contact piece 7271 contacts mating terminal 32 (the second connection terminal) is larger than, for example, a configuration in which one end of bottom piece 7270 on second curved portion 7272 side or a portion of second curved portion 7272 is fixed to the housing and cannot deform. Accordingly, terminal 72 (the first connection terminal) easily elastically deforms easily, accordingly ensuring the contact reliability between terminal 72 (the first connection terminal) and mating terminal 32 (the second connection terminal).

### (2) Details

Connector device 100 will be detailed below with reference to the drawings.

Connector device 100 includes first connector 5 and second connector 1. Second connector 1 is configured to be fitted to first connector 5 from above along first axis Al with respect to first connector 5.

### (2.1) First Connector

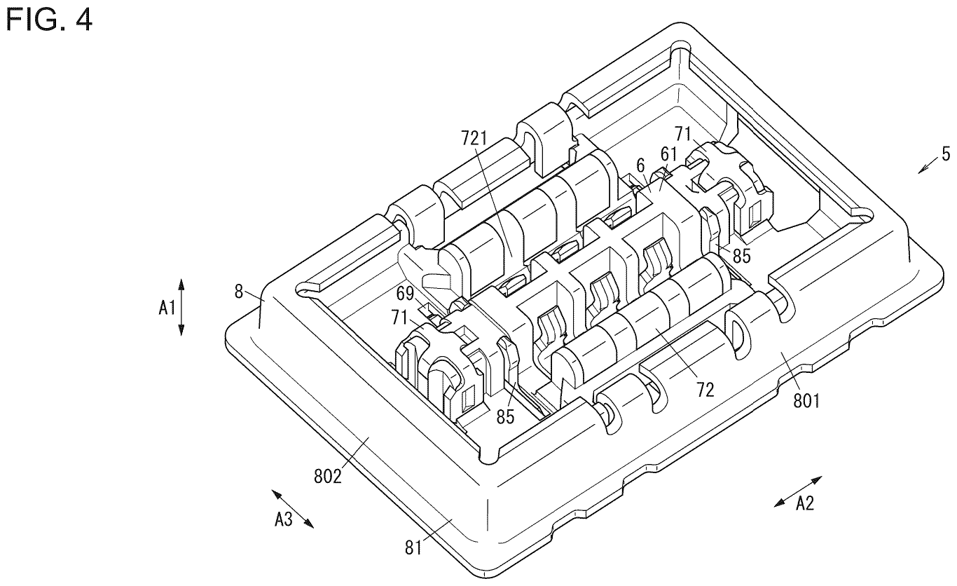

As illustrated in FIGS. 1 and 4, first connector 5 includes first housing 6, first terminals 7, and first shield 8.

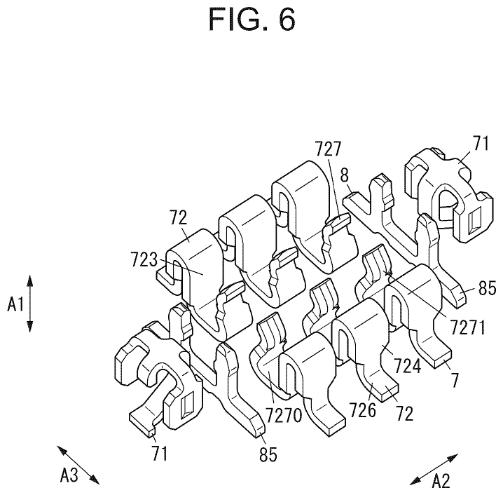

First connector 5 is a socket (female connector), and, as illustrated in FIGS. 4 to 6, includes first housing 6, plural (here, eight) first terminals 7, and first shield 8. First terminals 7 are held by first housing 6.

### (2.1.1) First Housing

As illustrated in FIG. 5, first housing 6 is made of an insulating resin having a flat and substantially rectangular parallelepiped shape elongated in second axis A2. Both sides of first housing 6 on third axis A3 in a central portion on second axis A2 are cut out in a substantially rectangular shape when viewed in first axis A1. Both sides of first housing 6 on third axis A3 in a central portion on second axis A2 are cut out in a substantially rectangular shape when viewed in first axis A1.

As illustrated in FIG. 5, first housing 6 includes first inner bottom wall 66 (the “bottom wall” described above), first inner wall 67 (the “first wall portion” described above), first outer bottom wall 60, first outer peripheral wall 64, and central wall portion 61 (the “second wall portion” described above). First inner bottom wall 66, first inner wall 67, first outer bottom wall 60, first outer peripheral wall 64, and central wall portion 61 are integrally formed.

Central wall portion 61 protrudes upward from first inner bottom wall 66 along first axis A1. Central wall portion 61 has a pair of side surfaces 612 disposed on both sides of upper surface 610 on third axis A3 perpendicular to first axis A1 and second axis A2.

As illustrated in FIG. 5, central wall portion 61 has recesses 615 therein. In accordance with the embodiment, central wall portion 61 has plural (for example, six) recesses 615 therein. The (six) recesses 615 are formed in both side surfaces of central wall portion 61 on third axis A3, three recesses on each side, and arranged along second axis A2.

More specifically, central wall portion 61 includes plural (for example, eight) partition walls 6150 and intermediate wall 6151. Intermediate wall 6151 has a wall shape extending along second axis A2. Each partition wall 6150 has a wall shape extending from intermediate wall 6151 along third axis A3. A lower end of each partition wall 6150 is connected to first inner bottom wall 66.

Plural (eight) partition walls 6150 are formed on both side surfaces of intermediate wall 6151 on third axis A3, four walls on each side, and are arranged along second axis A2. Four partition walls 6150 provided on one side of intermediate wall 6151 on third axis A3 equally divide (into three) a space on one side of intermediate wall 6151 on third axis A3. Four partition walls 6150 provided on the other side of intermediate wall 6151 on third axis A3 equally divide (into three) a space on the other side of intermediate wall 6151 on third axis A3. Recess 615 is surrounded by the pair of adjacent partition walls 6150 and intermediate wall 6151.

First inner bottom wall 66 has a rectangular plate shape elongated in second axis A2. First inner bottom wall 66 has through-hole 65 therein. In accordance with the present embodiment, first inner bottom wall 66 has plural (for example, six) through-holes 65 therein. Plural (six) through-holes 65 are formed in both sides of central wall portion 61 on third axis A3, three holes on each side, and arranged along second axis A2. Six through-holes 65 are connected to six recesses 615 along first axis A1, respectively. That is, the entire space in recess 615 pass along first axis A1 and overlaps through-hole 65 in bottom wall (first inner bottom wall 66). Through-holes 65 adjacent to each other on second axis A2 are not connected to each other, and are separated by portion 660 of first inner bottom wall 66 and partition wall 6150 (see FIG. 14).

First inner walls 67 protrude upward from peripheral edges of first inner bottom wall 66. First inner walls 67 are a pair of walls elongated in second axis A2. The pair of first inner walls 67 are disposed near a center of first inner bottom wall 66 on second axis A2 at both ends on third axis A3. As illustrated in FIG. 5, each first inner wall 67 integrally includes wall-shaped main body portion 671 located relatively inside third axis A3 and wall-shaped side portion 672 located relatively outside third axis A3. Recess 670 in which a part of first connection terminal 72 (first contact piece 723 and side piece 724) are disposed is provided in main body portion 671 of first inner wall 67 over both side surfaces and the upper surface on third axis A3. For example, three recesses 670 are provided in each of the pair of first inner walls 67.

First outer bottom wall 60 includes four partial bottom walls with rectangular shapes extending on a plane perpendicular to first axis A1 from four corners of first inner bottom wall 66.

First outer peripheral wall 64 protrudes upward from a peripheral edge of first outer bottom wall 60. First outer peripheral wall 64 has a rectangular frame shape in which a central portion of each of four sides is cut out when viewed in first axis A1 (hereinafter, also referred to as a “plan view”). First outer peripheral wall 64 extends in a circumferential direction.

Central wall portion 61 has a rectangular parallelepiped shape elongated in second axis A2 and protrudes upward from a center of first inner bottom wall 66. A portion surrounded by an inner bottom surface of first inner bottom wall 66, an inner side surface of first inner wall 67, and an outer side surface of central wall portion 61 demarcates recess 601 into which second connector 1 enters. Specifically, second inner peripheral wall 902 of second connector 1 is disposed in recess 601.

A portion surrounded by an end surface of first inner wall 67 on second axis A2, an inner bottom surface of first outer bottom wall 60, and an inner side surface of first outer peripheral wall 64 demarcates recess 602. Second outer peripheral wall 905 of second connector 1 is disposed in recess 602 while first connector 5 is fitted to second connector 1.

First housing 6 holds first terminals 7 and first shield 8.

As illustrated in FIG. 4, in accordance with the present embodiment, each of some (six) first terminals 7 (first connection terminals 72) among plural (eight) first terminals 7 is disposed across first inner wall 67 and recess 615 (see FIG. 5) of central wall portion 61. Specifically, three first connection terminals 72 are disposed on each of the pair of first inner walls 67. In the present embodiment, remaining first terminals 7 (first particular terminals 71) among plural (eight) first terminals 7 are disposed on central wall portion 61 and held by first housing 6. First particular terminals 71 are disposed on upper surface 610, end surface 611, and side surface 612 of central wall portion 61 at both ends of central wall portion 61 along second axis A2.

As illustrated in FIG. 4, in the present embodiment, first outer shield 81 of first shield 8 is adjacent to first outer peripheral wall 64 along first outer peripheral wall 64. In the present embodiment, first inner shield 85 of first shield 8 is disposed in groove hole 69 (see FIG. 5) formed in first housing 6.

### (2.1.2) First Terminal

First terminal 7 is formed by bending a metal plate strip. First terminal 7 is plated with gold. Each of first terminals 7 contacts a corresponding one of second terminals 3 of second connector 1 in the fitted state where first connector 5 is fitted to second connector 1.

First terminals 7 include first connection terminals 72 (above-described “terminal”) and first particular terminals 71.

First terminals 7 include one or more first particular terminals 71. First terminals 7 include one or more terminals (first connection terminals 72) other than first particular terminal 71. Here, two of eight first terminals 7 are first particular terminals 71, and the remaining six are first connection terminals 72.

Two first particular terminals 71 are disposed on both end sides of second axis A2 in first connector 5. Two first particular terminals 71 are disposed between both ends of central wall portion 61.

Six first connection terminals 72 are arranged along second axis A2 in a region between two first particular terminals 71 on second axis A2 while being divided into three on each side along third axis A3. Three of six first connection terminals 72 are held by each of the pair of first inner walls 67. Six first connection terminals 72 are disposed for sets of six recesses 615 and six through-holes 65, respectively.

Two first particular terminals 71 and six first connection terminals 72 are provided integrally with first housing 6 by insert molding.

First connection terminals 72 include a terminal configured to transmit a signal. A part or all of plural (for example, six) first connection terminals 72 may be configured to transmit electric power. Six first connection terminals 72 have the same shape. First connection terminals 72 may include a terminal having a different shape.

First particular terminal 71 is configured to transmit a signal having a higher frequency than first connection terminal 72. Two first particular terminals 71 have the same shape.

As described above, first connection terminal 72 includes connection piece 726, side piece 724, first contact piece 723, first curved portion 729, and contact arm 727 (see FIG. 11A).

Connection piece 726 has a substantially rectangular flat plate shape having a thickness along first axis A1. A lower surface of connection piece 726 is exposed to a lower surface of first housing 6. Connection piece 726 is configured to be connected to a conductive pattern 922 of first circuit board 92.

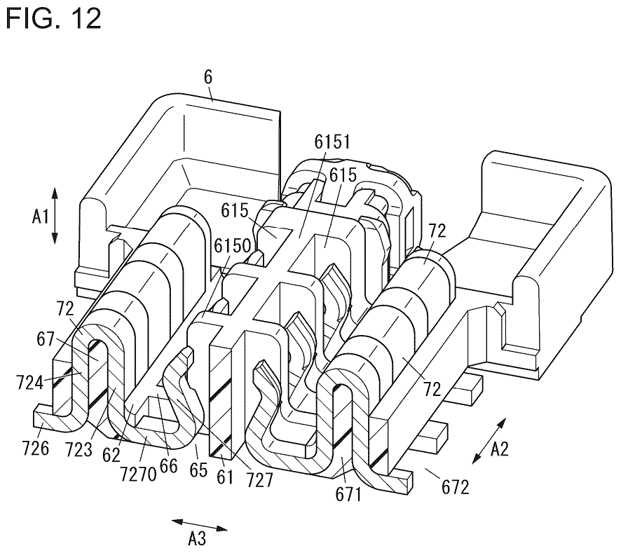

First contact piece 723 has a plate shape having a thickness along third axis A3. First contact piece 723 is disposed in recess 670 formed in main body portion 671 of first inner wall 67 of first housing 6. As illustrated in FIG. 12, for example, an inner surface of first contact piece 723 on third axis A3 is flush with an inner surface of main body portion 671 of first inner wall 67 on third axis A3.

Facing surfaces of first contact piece 723 and second contact piece 7271 facing each other contact second connection terminal 32 of second connector 1 in the fitted state. First contact piece 723 contacts extension piece 322 of second connection terminal 32 of second connector 1 in the fitted state (see FIG. 10).

As illustrated in FIG. 11B, first contact piece 723 may have recess 7233 contactable with protrusion 3220 formed on extension piece 322 of second connection terminal 32.

Side piece 724 has a plate shape having a thickness along third axis A3. Side piece 724 connects connection piece 726 to the upper end of first contact piece 723. Side piece 724 has an upper portion exposed from first housing 6 and a lower portion embedded in first inner wall 67 of first housing 6. The lower portion of side piece 724 is disposed between main body portion 671 and side portion 672 of first inner wall 67 of first housing 6. A wall portion of housing (first housing) 6 thus includes first wall portion 67 (the first inner wall) in which side piece 724 of terminal (first connection terminal) 72 is disposed. Side piece 724 has a step on both side surfaces such that a width (along second axis A2) of the lower portion is less than that of the upper portion.

First curved portion 729 connects lower end 7230 of first contact piece 723 to bottom piece 7270 of contact arm 727. In FIG. 13, boundary 72B between first curved portion 729 and first contact piece 723 is indicated by a one-dot chain line.

A lower portion of first contact piece 723 toward lower end 7230 extends linearly. An end portion of bottom piece 7270 toward first end 7201 extends linearly. First curved portion 729 is curved roundly from lower end 7230 of first contact piece 723 toward the inside of third axis A3 when viewed along second axis A2 such that the lower portion toward lower end 7230 and the end portion toward first end 7201 extend substantially perpendicularly to each other.

As illustrated in FIG. 13, first curved portion 729 has curved upper surface 7290 and curved lower surface 7291 opposite to upper surface 7290. Upper surface 7290 is connected to a surface of first contact piece 723 facing second contact piece 7271.

Upper surface 7290 and lower surface 7291 of first curved portion 729 are covered by first housing 6, and at least a part of first curved portion 729 is embedded in first housing 6. In a cross section of the connector perpendicular to second axis A2, at least one of upper surface 7290 and lower surface 7291 of first curved portion 729 is preferably entirely covered by first housing 6.

At least a part of lower surface 7291 of first curved portion 729 contacts a lower portion of main body portion 671 of first inner wall 67 of first housing 6 and is covered by main body portion 671. As illustrated in FIGS. 12 and 13, first housing 6 further includes covering portion 62 that covers upper surface 7290 of first curved portion 729 and lower end 7230 of first contact piece 723. As illustrated in FIG. 5, covering portion 62 is connected to main body portion 671 of first inner wall 67. As illustrated in FIGS. 12 and 14, covering portion 62 continuously covers upper surface 7290 of first curved portion 729 along second axis A2. Covering portion 62 is formed integrally with main body portion 671 of first inner wall 67 and first inner bottom wall 66 when first housing 6 is formed by insert molding.

As illustrated in FIGS. 12 and 13, covering portion 62 has inclined surface 620 continuously connected to upper surface 6601 of first inner bottom wall 66 and the wall portion (main body portion 671 of first inner wall 67). In accordance with the present embodiment, inclined surface 620 is a curved surface. Inclined surface 620 covers the lower portion of first contact piece 723 toward lower end 7230. For example, inclined surface 620 is curved from an upper end of inclined surface 620 toward the inside of third axis A3 along upper surface 7290 of first curved portion 729. Covering portion 62 having inclined surface 620 continuously connected to upper surface 6601 of first inner bottom wall 66 and the wall portion (first wall portion 67) increases the holding force with which first housing 6 holds first connection terminal 72.

As described above, contact arm 727 includes bottom piece 7270, second curved portion 7272, and second contact piece 7271.

Bottom piece 7270 has a plate shape having a thickness along an axis (for example, first axis A1) intersecting with third axis A3. Bottom piece 7270 extends linearly along the facing axis (for example, third axis A3). First end 7201 of bottom piece 7270 is connected to lower end 7230 of first contact piece 723 via first curved portion 729.

As illustrated in FIG. 13, bottom piece 7270 is exposed from first housing 6. In particular, first end 7201 of bottom piece 7270 is exposed from first housing 6. Contact arm 727 is preferably exposed from first housing 6 at boundary 72A between first end 7201 of bottom piece 7270 and first curved portion 729. Specifically, a range of first connection terminal 72 in which covering portion 62 is formed is a range up to boundary 72A.

Bottom surface 661 of a portion of first inner bottom wall 66 covering lower surface 7291 of first curved portion 729 is preferably flush with lower surface 7203 at a portion of boundary 72A between first end 7201 of bottom piece 7270 and first curved portion 729.

Contact arm 727 is configured to elastically deform along a plane including first axis A1 and third axis A3 such that a gap between contact arm 727 and first contact piece 723 increases along third axis A3 when fitted.

As illustrated in FIG. 13, a lower surface of bottom piece 7270 is preferably higher than the lower surface of connection piece 726. The lower surface of bottom piece 7270 higher than the lower surface of connection piece 726 allows bottom piece 7270 to elastically deform such that second end 7202 of bottom piece 7270 moves downward while first connector 5 is connected to first circuit board 92 (see FIG. 10). This configuration enlarges a movable range of contact arm 727, and ensures the contact reliability.

Second contact piece 7271 has a plate shape having a thickness in a cross section perpendicular to second axis A2, extends upward from second curved portion 7272, and is curved in a C shape when viewed along second axis A2. An outer surface of second contact piece 7271 on third axis A3 is inclined such that the thickness of second contact piece 7271 gradually decreases from both sides of second contact piece 7271 along second axis A2 to a central portion second contact piece 7271 along second axis A2.

In the fitted state, second contact piece 7271 faces recess 3210 (see FIG. 10) of contact piece 321 of second connection terminal 32 and contacts contact piece 321. Second contact piece 7271 may be inserted into recess 3210 of contact piece 321.

Second curved portion 7272 connects the lower end of second contact piece 7271 to second end 7202 of bottom piece 7270. As illustrated in FIG. 13, second curved portion 7272 is curved roundly with a radius of curvature less than first curved portion 729 when viewed along second axis A2. The radius of curvature of second curved portion 7272 may be equal to or larger than a radius of curvature of first curved portion 729.

As described above, first connection terminal 72 is fixed to first housing 6 such that upper surface 7290 and lower surface 7291 of first curved portion 729 are covered by first housing 6 and first curved portion 729 is embedded in first housing 6. In this state, contact arm 727 of first connection terminal 72 is disposed in recess 615 of central wall portion 61 of first housing 6 and is movable with respect to first housing 6. Since contact arm 727 is thus movable with respect to first housing 6, entire contact arm 727 may be bent when second contact piece 7271 contacts mating terminal (second connection terminal) 32. Accordingly, first connection terminal 72 elastically deforms easily, and the contact reliability between first connection terminal 72 and second connection terminal 32 can be ensured.

In first connector 5 according to the present embodiment, central wall portion 61 (the second wall portion) includes the pair of partition walls 6150 disposed on both sides of first connection terminal 72 (the terminal) along second axis A2 and protruding along first axis A1, and intermediate wall 6151 facing contact arm 727 on third axis A3 and connecting the pair of partition walls 6150 to each other. Recess 615 is surrounded by the pair of partition walls 6150 and intermediate wall 6151. An entire space in recess 615 surrounded by the pair of partition walls 6150 and intermediate wall 6151 passes along first axis A1 and overlaps through-hole 65 of first inner bottom wall (bottom wall) 66. Accordingly, a space in which contact arm 727 may be bent is secured in first housing 6. For example, it is possible to easily perform an electrical inspection of contact arm 727 by causing a probe to contact contact arm 727 from an outside. It is possible to easily inspect whether a foreign matter adheres to second contact piece 7271 by, e.g., visual inspection.

As illustrated in FIG. 1, first connection terminal 72 is disposed in first connection terminal region 721 surrounded by first outer shield 81 and first inner shield 85. In accordance with the present embodiment, first connection terminal region 721 is a region surrounded by first outer shield 81 and two first inner shields 85.

As illustrated in FIG. 10, first connection terminal 72 is connected to conductive pattern 922 (a conductive pattern different from a conductive pattern to which first particular terminal 71 is connected) of first circuit board 92. Specifically, first connection terminal 72 is connected to conductive pattern 922 of first circuit board 92 on the lower surface (a surface intersecting with a thickness direction) of connection piece 726.

### (2.1.3) First Shield

First shield 8 is an electromagnetic shield configured to shield electromagnetic waves. First shield 8 reduces leakage, to the outside, of noise (electromagnetic waves) caused by signal currents flowing through second terminal 3 and first terminal 7. First shield 8 is in contact with second shield 4 in the fitted state. First shield 8 reduces an influence of noise (electromagnetic waves) on the signal currents flowing through second terminal 3 and first terminal 7.

As illustrated in FIG. 1, first shield 8 surrounds at least one of first terminals 7. First shield 8 surrounds at least first particular terminal 71 among plural first terminals 7. First shield 8 surrounds plural first particular terminals 71 and surrounds plural first connection terminals 72. First shield 8 is held by first housing 6.

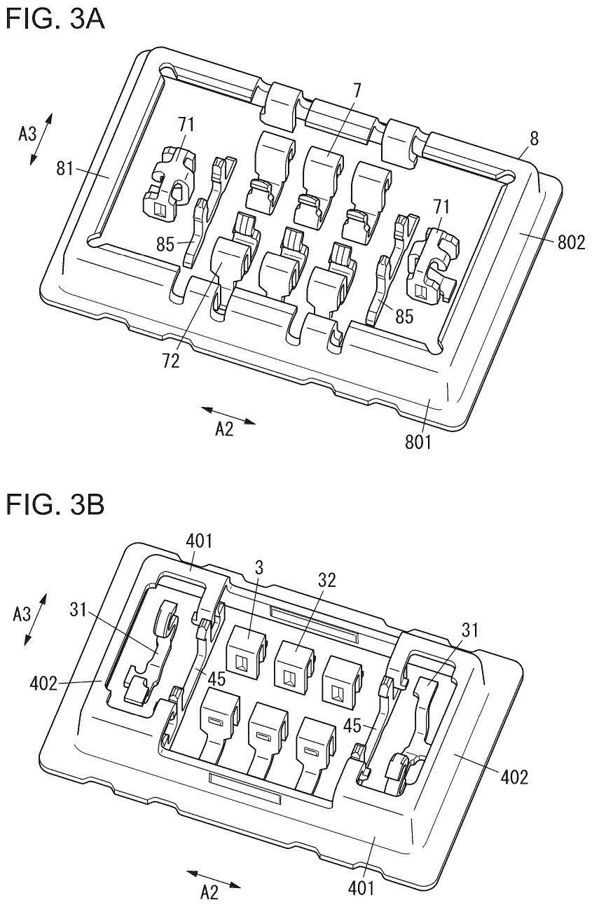

As illustrated in FIG. 3A, first shield 8 includes first outer shield 81 and first inner shields 85.

As illustrated in FIG. 1, first outer shield 81 is held by first housing 6. First outer shield 81 surrounds plural first terminals 7.

As illustrated in FIG. 3A, first outer shield 81 includes a pair of first lateral shields 801 arranged along third axis A3 perpendicular to first axis A1, and a pair of first longitudinal shields 802 connecting the pair of first lateral shields 801 to each other. The pair of first lateral shields 801 and the pair of first longitudinal shields 802 extend in a circumferential direction.

First inner shield 85 is disposed between two first terminals 7 among plural first terminals 7. Specifically, first inner shield 85 is disposed between first particular terminal 71 and first connection terminal 72.

As illustrated in FIGS. 1 and 3A, in accordance with the present embodiment, first shield 8 includes two first inner shields 85. Two first inner shields 85 are arranged along second axis A2 to separate one first particular terminal 71 from plural (six) first connection terminals 72 and separate plural first connection terminals 72 from the other first particular terminal 71.

In this way, first inner shield 85 disposed between the two first particular terminals 71 reduces an influence of noise caused by signal currents flowing through one first particular terminal 71 on signal currents flowing through the other first particular terminal 71 and first connection terminal 72. That is, insulation between two first particular terminals 71 can be improved.

### (2.2) Second Connector

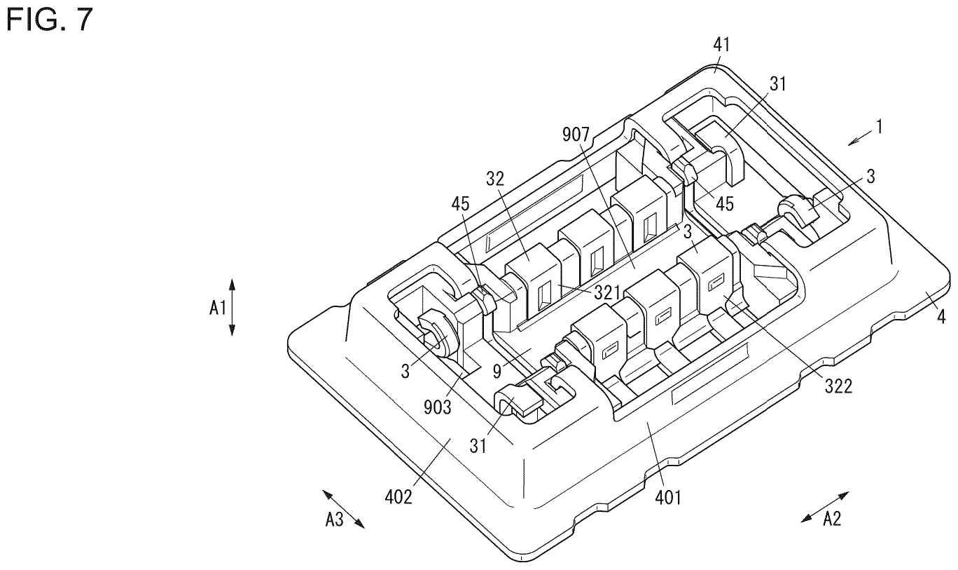

Second connector 1 is a header (male connector), and as illustrated in FIGS. 7 to 9, includes second housing 9, plural (here, eight) second terminals 3, and second shield 4. In FIGS. 7 to 9, second connector 1 is illustrated upside down for convenience.

### (2.2.1) Second Housing

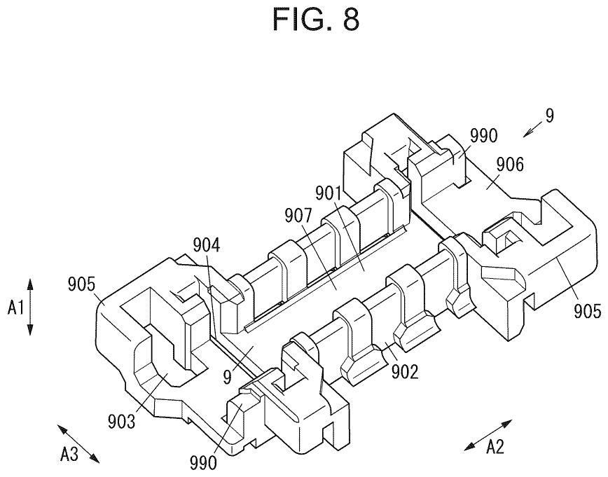

As illustrated in FIG. 8, second housing 9 is made of an insulating resin material with a flat shape elongated in second axis A2. Both sides of second housing 9 on third axis A3 in a central portion on second axis A2 are cut out in a substantially rectangular shape when viewed along first axis A1. Second housing 9 has substantially an H shape in plan view.

As illustrated in FIG. 8, second housing 9 includes second inner bottom wall 901, second inner peripheral wall 902, second outer bottom wall 906, and second outer peripheral wall 905. Second inner bottom wall 901, second inner peripheral wall 902, second outer bottom wall 906, and second outer peripheral wall 905 are integrally formed with one another.

Second inner bottom wall 901 has a rectangular plate shape elongated in second axis A2.

Second inner peripherals wall 902 protrudes downward (upward in FIG. 8) from both ends of second inner bottom wall 901 on third axis A3. Second inner peripheral wall 902 includes a pair of inner walls elongated in second axis A2. A portion surrounded by an inner bottom surface of second inner bottom wall 901 and inner side surfaces of second inner peripheral wall 902 demarcates recess 907 into which first connector 5 enters in the fitted state. Specifically, central wall portion 61 of first connector 5 is accommodated in recess 907.

Second outer bottom wall 906 includes two partial bottom walls extending in a rectangular shape from both ends of second inner bottom wall 901 toward the outside of second axis A2.

Second outer peripheral wall 905 protrudes downward from the peripheral edge of second outer bottom wall 906.

Second outer bottom wall 906 has an accommodation hole 903 therein in which second particular terminal 31 is disposed. Groove hole 904 in which second inner shield 45 is held is formed in second outer bottom wall 906.

Second housing 9 holds plural second terminals 3 and second shield 4.

In accordance with the present embodiment, second inner peripheral wall 902 extends along second axis A2 and includes a pair of side walls facing each other along second axis A2. Some (six) second terminals 3 (second connection terminals 32) among plural (eight) second terminals 3 are disposed on the pair of side walls of second inner peripheral wall 902. Specifically, three second connection terminals 32 are held on each of the pair of side walls of second inner peripheral wall 902. Second connection terminal 32 is disposed in a recess provided in second inner peripheral wall 902. The remaining second terminals 3 (second particular terminals 31) among plural (eight) second terminals 3 are disposed in accommodation hole 903.

In accordance with the present embodiment, second outer shield 41 is disposed along second outer peripheral wall 905. In the present embodiment, second inner shield 45 of second shield 4 is disposed in groove hole 904 formed in second housing 9.

### (2.2.2) Second Terminal

Second terminal 3 is formed by bending a strip metal plate. Second terminal 3 is plated with gold. Second terminal 3 is held by second housing 9.

Plural second terminals 3 include one or more second particular terminals 31. Plural second terminals 3 include one or more terminals (second connection terminals 32, the above-described “mating terminal”) other than second particular terminal 31. Two of the eight second terminals 3 are second particular terminals 31, and the remaining six are second connection terminals 32. Two second particular terminals 31 are disposed on both sides of second connector 1 on second axis A2. Two second particular terminals 31 are respectively disposed on protruding walls 990 facing accommodation hole 903 on third axis A3.

Six second connection terminals 32 are arranged along second axis A2 in a region between two second particular terminals 31 on second axis A2 while being divided into three on each side along third axis A3. Three of six second connection terminals 32 are held on each of the pair of side walls of second inner peripheral wall 902.

Second connection terminals 32 includes a terminal configured to transmit a signal. A part or all of plural (for example, six) second connection terminals 32 may be terminals configured to transmit electric power. Here, six second connection terminals 32 have the same shape. Second connection terminals 32 may include a terminal having a different shape.

Second particular terminal 31 is a terminal configured to transmit a signal with a high frequency to the second connection terminal. Two second particular terminals 31 have the same shape.

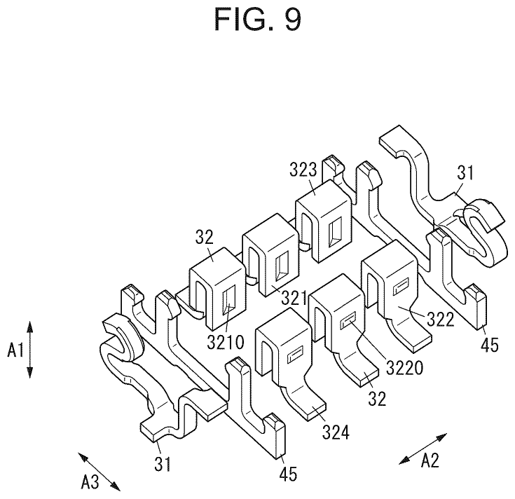

As illustrated in FIG. 9, second connection terminal 32 includes contact piece 321, extension piece 322, linking piece 323, and terminal piece 324 which are integrally formed to one another. Each of contact piece 321 and extension piece 322 has a contact point contacting first connection terminal 72 in the fitted state.

Contact piece 321 substantially has a rectangular flat plate shape having a thickness along third axis A3. As illustrated in FIG. 7, an inner surface of contact piece 321 on third axis A3 is exposed in recess 907 of second housing 9. Recess 3210 is formed in the inner surface of contact piece 321 on third axis A3.

Extension piece 322 substantially has a rectangular flat plate shape having a thickness along third axis A3. As illustrated in FIG. 7, an outer surface of extension piece 322 on third axis A3 is exposed to an outer surface of second housing 9. Protrusion 3220 is formed on the outer surface of extension piece 322 on third axis A3. Protrusion 3220 of extension piece 322 contacts an inner surface of first contact piece 723 on third axis A3 of first connection terminal 72 (or recess 7233 formed therein).

Linking piece 323 connects a lower end of extension piece 322 to a lower end of contact piece 321. A lower surface of linking piece 323 is exposed to a lower surface of second inner bottom wall 901 of second housing 9.

Terminal piece 324 substantially has a rectangular flat plate shape having a thickness along first axis A1. Terminal piece 324 protrudes outward along third axis A3 from an upper end of extension piece 322. As illustrated in FIG. 1, an upper surface of terminal piece 324 is exposed to an upper surface of second housing 9.

Second connection terminal 32 is formed integrally with second housing 9 by, for example, simultaneous molding.

Second connection terminal 32 is connected to conductive pattern 912 (a conductive pattern different from a conductive pattern to which second particular terminal 31 is connected) of second circuit board 91. Specifically, second connection terminal 32 is connected to conductive pattern 912 of second circuit board 91 on the upper surface (a surface intersecting with the thickness direction) of terminal piece 324.

### (2.2.3) Second Shield

Second shield 4 is an electromagnetic shield configured to shield electromagnetic waves. Second shield 4 reduces leakage, to the outside, of noise (electromagnetic waves) caused by signal currents flowing through second terminal 3 and first terminal 7. Second shield 4 reduces an influence of noise (electromagnetic waves) on the signal currents flowing through second terminal 3 and first terminal 7.

As illustrated in FIG. 3B, second shield 4 surrounds at least one of plural second terminals 3. Second shield 4 surrounds at least second particular terminal 31 among plural second terminals 3. Second shield 4 surrounds plural second particular terminals 31 and surrounds plural second connection terminals 32. Second shield 4 is held by second housing 9.

As illustrated in FIG. 3B, second shield 4 includes second outer shield 41 and second inner shield 45.

As illustrated in FIG. 7, second outer shield 41 is held by second outer peripheral wall 905 of second housing 9. Second outer shield 41 surrounds plural second terminals 3.

As illustrated in FIG. 3B, second outer shield 41 includes a pair of second lateral shields 401 and a pair of second longitudinal shields 402.

Second inner shield 45 is disposed between two second terminals 3 among plural second terminals 3. Second inner shield 45 is disposed between second particular terminal 31 and second connection terminal 32.

As illustrated in FIGS. 3A and 3B, in accordance with the present embodiment, second shield 4 includes two second inner shields 45. Two second inner shields 45 are arranged along second axis A2 to separate one second particular terminal 31 from plural (six) second connection terminals 32 and separate plural second connection terminals 32 from the other second particular terminal 31.

Second inner shield 45 thus disposed between the two second particular terminals 31 reduces an influence of noise caused by signal currents flowing through one second particular terminal 31 on signal currents flowing through the other second particular terminal 31 and second connection terminal 32. That is, insulation between two second particular terminals 31 can be improved.

### (2.3) Connection Device

As illustrated in FIG. 10, first connector 5 is connected to first circuit board 92. First connector 5 and first circuit board 92 constitute a first connection device. That is, the first connection device includes first connector 5 and first circuit board 92 to which first connector 5 is connected. Second connector 1 is connected to second circuit board 91. Second connector 1 and second circuit board 91 constitute a second connection device. That is, the second connection device includes second connector 1 and second circuit board 91 to which second connector 1 is connected.

### (2.4) Connector Device

A structure of connector device 100 in which first connector 5 is fitted to second connector 1 will be described below with reference to FIGS. 1, 2, and 10. As illustrated in FIG. 1, second connector 1 is fitted to first connector 5 from above first connector 5.

As illustrated in FIG. 10, in the fitted state, six first connection terminals 72 of first connector 5 contact to six second connection terminals 32 of second connector 1 to be electrically connected to six second connection terminals 32 of second connector 1, respectively. Accordingly, signals are transmitted and received between first circuit board 92 on which first connector 5 is mounted and second circuit board 91 on which second connector 1 is mounted via first connection terminal 72 and second connection terminal 32.

Specifically, second connection terminal 32 contacts first connection terminal 72 on the inner surface (a surface intersecting with the thickness direction) of contact piece 321 on third axis A3 and the outer surface (a surface intersecting with the thickness direction) of extension piece 322 on third axis A3. First connection terminal 72 contacts second connection terminal 32 on the inner surface (a surface intersecting with the thickness direction) of first contact piece 723 on third axis A3 and the outer surface (a surface intersecting with the thickness direction) of second contact piece 7271 on third axis A3.

In the fitted state, two first particular terminals 71 of first connector 5 contact two second particular terminals 31 of second connector 1 to be electrically connected to two second particular terminals 31 of second connector 1, respectively. Accordingly, signals can be transmitted and received between first circuit board 92 on which first connector 5 is mounted and second circuit board 91 on which second connector 1 is mounted via first particular terminal 71 and second particular terminal 31.

### SUMMARY

As described above, the connector (5) according to the first aspect is a connector to be fitted with the mating connector (1) from below along the first axis (A1). The connector (5) includes a housing (6) and a terminal (72). The housing (6) includes a bottom wall (66) and a wall portion protruding upward from the bottom wall (66). The bottom wall (66) has a through-hole (65) passing through the bottom wall along the first axis (A1), The terminal (72) is held by the housing (6). The terminal (72) includes a connection piece (726), a first contact piece (723), a side piece (724), a contact arm (727), and a first curved portion (729). The first contact piece (723) is configured to contact a mating terminal (32) of the mating connector (1). The side piece (724) connects the connection piece (726) to an upper end of the first contact piece (723). The side piece (724) includes a part embedded in the housing (6). The contact arm (727) is movable with respect to the housing (6). The first curved portion (729) which is curved connects a lower end of the first contact piece (723) to the contact arm (727). The contact arm (727) includes a second contact piece (7271), a bottom piece (7270), and a second curved portion (7272). The second contact piece (7271) faces the first contact piece (723) along a facing axis intersecting with the first axis (A1) and is configured to contact the mating terminal (32) of the mating connector (1). The bottom piece (7270) is disposed in the through-hole (65) and extends linearly along the facing axis. The bottom piece (7270) has a first end (7201) and a second end (7202) opposite to the first end (7201). The first end (7201) of the bottom piece is connected to the first curved portion (729) The second curved portion (7272) which is curved connects a lower end of the second contact piece (7271) to the second end (7202) of the bottom piece (7270). The housing (6) covers an upper surface (7290) and a lower surface (7291) of the first curved portion (729). The first curved portion (729) is embedded in the housing (6) such that the first end (7201) of the bottom piece (7270) of the contact arm (727) is exposed from the housing (6).

According to this aspect, the contact reliability between the terminals (32, 72) is ensured while increasing a holding force for holding the terminal (72) of the housing (6).

In a second aspect relating to the connector (5) of the first aspect, the first curved portion (729) is embedded in the housing (6) such that the contact arm (727) is exposed from the housing (6) at a boundary (72A) between the first end (7201) of the bottom piece (7270) and the first curved portion (729) of the contact arm (727).

According to this aspect, the contact reliability between the terminals (32, 72) is ensured while increasing the holding force for holding the terminal (72) of the housing (6).

In a third aspect relating to the connector (5) of the first or the second aspect, the housing (6) further includes a covering portion (62) covering the upper surface (7290) of the first curved portion (729) and the lower end of the first contact piece (723). The covering portion (62) has an inclined surface (620) continuously connected to an upper surface of the bottom wall (66) and the wall portion.

According to this aspect, the holding force for holding the terminal (72) of the housing (6) is increased.

In a fourth aspect relating to the connector (5) of any one of the first to third aspects, a lower surface of the bottom piece (7270) is higher than a lower surface of the connection piece (726).

According to this aspect, the contact reliability between the terminals (32, 72) is ensured.

In a fifth aspect relating to the connector (5) of any one of the first to fourth aspects, a bottom surface (661) of a portion of the bottom wall (66) covering the lower surface (7291) of the first curved portion (729) is flush with a lower surface (7203) of a portion of the bottom piece at the boundary (72A) between the first end (7201) of the bottom piece (7270) and the first curved portion (729).

According to this aspect, the contact reliability between the terminals (32, 72) is ensured while increasing the holding force for holding the terminal (72) of the housing (6).

In a sixth aspect relating to the connector (5) of any one of the first to fifth aspects, the wall portion includes a first wall portion (67) and a second wall portion (61). The first wall portion (67) has the side piece disposed thereon. The second wall portion (61) has a recess (615) in which the contact arm is disposed. The second wall portion (61) includes: a pair of partition walls (6150) disposed on both sides of the terminal (72) along a second axis (A2) perpendicular to the first axis (A1) and protruding along the first axis (A1); and an intermediate wall (6151) facing the contact arm (727) on a third axis (A3) perpendicular to the first axis (A1) and the second axis (A2). The intermediate wall (6151) connects the pair of partition walls (6150) to each other. The recess (615) is surrounded by the pair of partition walls (6150) and the intermediate wall (6151). An entire space in the recess (615) passes through the second wall portion along the first axis (A1) and overlaps the through-hole (65) in the bottom wall (66).

According to this aspect, the terminal (72) is easily inspected.

### REFERENCE MARKS IN THE DRAWINGS

1 mating connector (second connector)
5 connector (first connector)
6 housing (first housing)
32 mating terminal (second connection terminal)
62 covering portion
65 through-hole
66 bottom wall (first inner bottom wall)
72 terminal (first connection terminal)
72A boundary
615 recess
620 inclined surface
661 bottom surface
723 first contact piece
724 side piece
726 connection piece
727 contact arm
729 first curved portion
6150 partition wall
6151 intermediate wall
7201 first end
7202 second end
7203 lower surface
7270 bottom piece
7271 second contact piece
7272 second curved portion
7290 upper surface
7291 lower surface
A1 first axis
A2 second axis
A3 third axis

1. A connector configured to be fitted to a mating connector from below along a first axis, the connector comprising:
a housing including a bottom wall and a wall portion protruding upward from the bottom wall, the bottom wall having a through-hole passing through the bottom wall along the first axis; and
a terminal held by the housing, wherein
the terminal includes:
a connection piece;
a first contact piece configured to contact a mating terminal of the mating connector;
a side piece connecting the connection piece to an upper end of the first contact piece, the side piece including a part embedded in the housing;
a contact arm movable with respect to the housing; and
a first curved portion which is curved, the first curved portion connecting a lower end of the first contact piece to the contact arm,
the contact arm includes:
a second contact piece facing the first contact piece along a facing axis intersecting with the first axis, the second contact piece being configured to contact the mating terminal of the mating connector;
a bottom piece disposed in the through-hole and extending linearly along the facing axis, the bottom piece having a first end and a second end opposite to the first end, the first end being connected to the first curved portion; and
a second curved portion which is curved, the second curved portion connecting a lower end of the second contact piece to the second end of the bottom piece, wherein
the housing covers an upper surface and a lower surface of the first curved portion, and the first curved portion is embedded in the housing such that the first end of the bottom piece of the contact arm is exposed from the housing.

2. The connector according to claim 1, wherein the first curved portion is embedded in the housing such that the contact arm is exposed from the housing at a boundary between the first end of the bottom piece of the contact arm and the first curved portion.

3. The connector according to claim 1, wherein
the housing further includes a covering portion covering the upper surface of the first curved portion and the lower end of the first contact piece, and
the covering portion has an inclined surface connected to an upper surface of the bottom wall and the wall portion.

4. The connector according to claim 1, wherein a lower surface of the bottom piece is located higher than a lower surface of the connection piece.

5. The connector according to claim 2, wherein a bottom surface of a portion of the bottom wall covering the lower surface of the first curved portion is flush with a lower surface of a portion of the bottom piece at the boundary between the first end of the bottom piece and the first curved portion.

6. The connector according to claim 1, wherein
the wall portion includes a first wall portion and a second wall portion, the first wall portion having the side piece disposed thereon, the second wall portion having a recess in which the contact arm is disposed,
the second wall portion includes:
a pair of partition walls disposed on both sides of the terminal along a second axis perpendicular to the first axis and protruding along the first axis; and
an intermediate wall facing the contact arm along a third axis perpendicular to the first axis and the second axis, the intermediate wall connecting the pair of partition walls to each other,
the recess is surrounded by the pair of partition walls and the intermediate wall, and
an entire space in the recess passes through the second wall portion along the first axis and overlaps the through-hole in the bottom wall.
